(19) United States
(12) Patent Application Publication
(10) Pub. No.: US 2008/0291340 A1
(43) Pub. Date: Nov. 27, 2008

(54) Projection Type Video Display Apparatus

(75) Inventor: Shinichi HIRAI, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/124,067

(22) Filed: May 20, 2008

(30) Foreign Application Priority Data
May 21, 2007 (JP) 2007-134400

(51) Int. Cl. H04N 9/31

(52) U.S. Cl. 348/744; 348/E09.025

(57) ABSTRACT

Disclosed is a projection type video display apparatus including: a video projection section to generate projection light of a video to output through a projection lens; an imaging section to capture through a camera lens the video projected by the video projection section; a moving section to move the projection lens in a direction of changing focus of the video; and a control section to adjust the focus of the projected video, wherein the control section allows the video projection section to project a pre-set mark image and the imaging section to capture the projected video of the mark image to allow the moving section to operate so that the captured mark image is in focus, and thus adjusts the focus of the projected video.

### BACKGROUND OF THE INVENTION

1. Field of the Invention

The present invention relates to a projection type video display apparatus to project a video.

2. Description of Related Art

As a projection type video display apparatus there is a projector apparatus which projects a video on a screen. In a projector apparatus, typically, focus of the projected video is adjusted by bringing a distance between a screen and the projector apparatus in a predetermined length or by turning a knob to move a projection lens. There is also an apparatus with a function which automatically measures the distance to the screen and automatically adjusts the focus by adjusting the position of the projection lens according to the measured distance.

The following techniques are disclosed as techniques related to the present invention. For example, Japanese Patent Application Laid-Open Publication No. 2006-098789 discloses a technique which pastes a plurality of points on a screen and images these points to correct the size and the like of the projected video according to the plurality of points. Japanese Patent Application Laid-Open Publication No. 2006-064913 discloses a technique which calculates a direction and distance of a screen by placing a plurality of marks on the screen and imaging this with an omnidirectional camera. Japanese Patent Application Laid-Open Publication No. 2005-241713 discloses a technique which marks positions of four corners of an image and adjusts a position of an optical modulator with these markings. Japanese Patent Application Laid-Open Publication No. 2003-289485 discloses a technique which images a projected video with a camera and performs keystone correction of the projected video. Japanese Patent Application Laid-Open Publication No. 2003-015218 discloses a technique which projects a fiducial mark and performs a registration of two projected images according to this fiducial mark.

It is complicated for a user to manually adjust the focus of a projector apparatus. In apparatuses which adjust the focus by automatically measuring the distance to the screen, there is a problem of not being able to measure the distance depending on a color or type of screen, and a normal adjustment of the focus cannot be done.

### SUMMARY OF THE INVENTION

It is, therefore, a main object of the present invention to provide a projection type video display apparatus which can perform focus adjustment in various situations such as being able to automatically adjust the focus without causing trouble to the user and being able to adjust the focus regardless of the screen configuration.

According to a first aspect of the present invention, there is provided a projection type video display apparatus comprising:

a video projection section to generate projection light of a video to output through a projection lens;

an imaging section to capture through a camera lens the video projected by the video projection section;

a moving section to move the projection lens in a direction of changing focus of the video; and

a control section to adjust the focus of the projected video, wherein

the control section allows the video projection section to project a pre-set mark image and the imaging section to capture the projected video of the mark image to allow the moving section to operate so that the captured mark image is in focus, and thus adjusts the focus of the projected video.

Preferably, the projection type video display apparatus further comprises a storage section to store image data of the mark image, wherein

the control section allows the video projection section to project the mark image based on the image data.

Preferably, in the projection type video display apparatus, the mark image is an image with a bright portion and a dark portion arranged alternately.

Preferably, in the projection type video display apparatus, the control section determines whether or not the projected video is in focus by comparing areas of the bright portion and the dark portion of the mark image captured by the imaging section.

Preferably, the projection type video display apparatus further comprises:

a video input section to receive input of data or signal of a video; and

an image insertion section to insert a display content of a character or design in the data or signal of the video, wherein

the mark image is inserted in the projected video by the image insertion section while a video input from the video input section is projected by the video projection section.

Preferably, the projection type video display apparatus further comprises an operation section to switch between whether or not to project the mark image.

According to a second aspect of the present invention, there is provided a projection type video display apparatus comprising:

a video projection section to generate projection light of a video to output through a projection lens;

an imaging section to capture through a camera lens the video projected by the video projection section;

a storage section to store image data of a mark image in which a bright portion and a dark portion are arranged alternately;

a video input section to receive input of data or signal of a video;

an image insertion section to insert a display content of a character or design in the data or signal of the video;

a moving section to move the projection lens in a direction of changing focus of the video; and

a control section to adjust the focus of the projected video, wherein

the control section allows the mark image to be inserted in the projected video by the image insertion section while a video input from the video input section is projected by the video projection section and allows the imaging section to capture the projected video of the mark image to determine whether or not the projected video is in focus by comparing areas of the bright portion and the dark portion of the mark image while allowing the moving section to operate, and thus adjusts the focus of the projected video.

### BRIEF DESCRIPTION OF THE DRAWINGS

The above and other objects, advantages, and features of the present invention will become more fully understood from the detailed description given hereinbelow and the appended drawings which are given by way of illustration only, and thus are not intended as a definition of the limits of the present invention, and wherein:

FIG. 1 is a block diagram showing a structure of a projection type video display apparatus according to the present embodiment;

FIG. 2 is a diagram showing one example of a mark image stored in a storage section;

FIG. 3 is an explanatory diagram showing a status during focus adjustment;

FIG. 4A is an explanatory diagram showing a projected mark image in front focus;

FIG. 4B is an explanatory diagram showing a projected mark image in focus;

FIG. 4C is an explanatory diagram showing a projected mark image in back focus; and

FIG. 5 is a flowchart showing a procedure of the focusing processing performed by the CPU.

### DESCRIPTION OF THE PREFERRED EMBODIMENTS

The best mode for carrying out the projection type video display apparatus according to the present invention will be explained in detail with reference to the drawings.

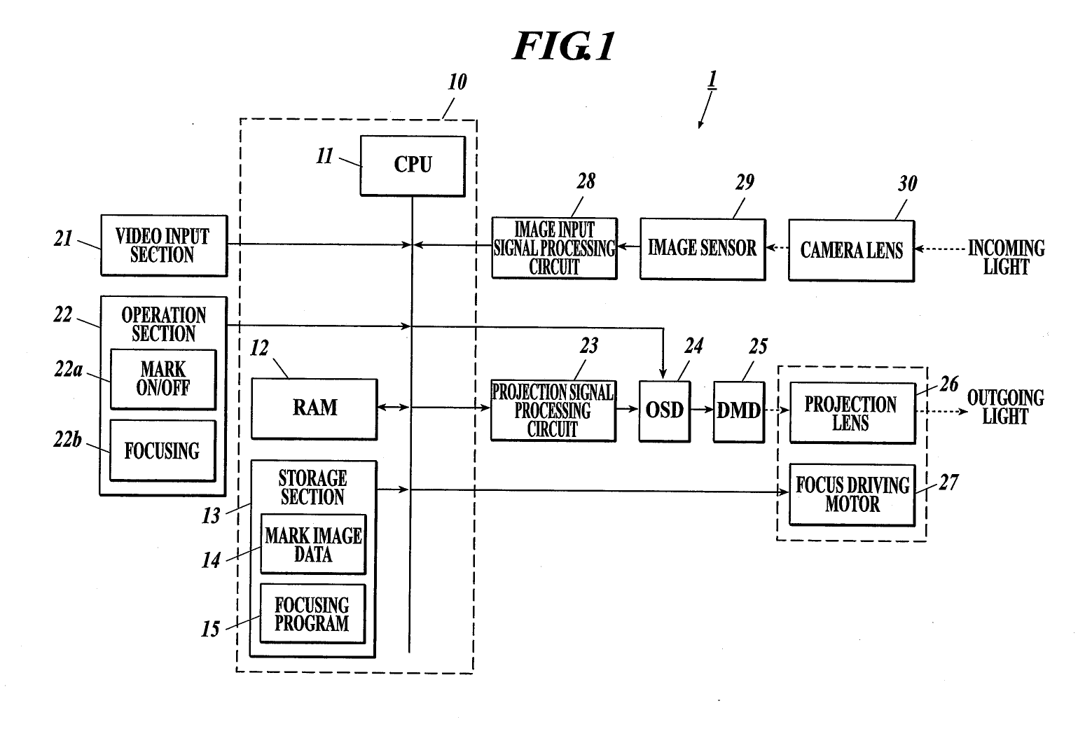

FIG. 1 is a block diagram showing a structure of a projection type video display apparatus according to the present embodiment.

The projection type video display apparatus 1 of the present embodiment is an apparatus which performs video display by projecting a light of a video on a screen. The projection type video display apparatus 1 comprises a video input section 21 for performing signal processing of input of a video signal or video data received from outside, an operation section 22 which includes a plurality of operation buttons for receiving input of an operation instruction from a user, a microcomputer 10 as a control section for generally controlling the apparatus, a Digital Micromirror Device (DMD) 25 as a video projection section which reflects a lamp light with respect to each dot in a video to generate a projected light of the video, a signal processing circuit 23 which generates a projection video signal from the video data or the video signal to be supplied to the DMD 25, an On-Screen Display (OSD) processing section 24 for inserting a signal of a character or a design in the signal supplied to the DMD 25, a projection lens 26 for projecting a reflected light of the DMD 25 onto the screen, a focus driving motor 27 as a moving section for performing a focus adjustment by moving the projection lens 26, a camera lens 30 for capturing the video projected on the screen, an image sensor 29 such as a Charge Coupled Device (CCD) as an imaging section for imaging the video captured by the camera lens 30, a signal processing circuit 28 for converting the image signal output from the image sensor 29 into data, and the like.

The microcomputer 10 is provided with a Central Processing Unit (CPU) 11 for performing a control program, a Random Access Memory (RAM) 12 for providing memory space for the CPU 11 to work in, a storage section 13 such as a flash memory as a storage section for storing control data and a control program, and the like. The storage section 13 stores as computer data and a computer program image data 14 which represents a mark image, a focus adjustment processing program 15 for adjusting the focus of the projected video, and the like.

The operation section 22 is provided with an operation section 22a for turning the projection of the mark image on and off and an operation section 22b for starting the processing of the automatic focusing.

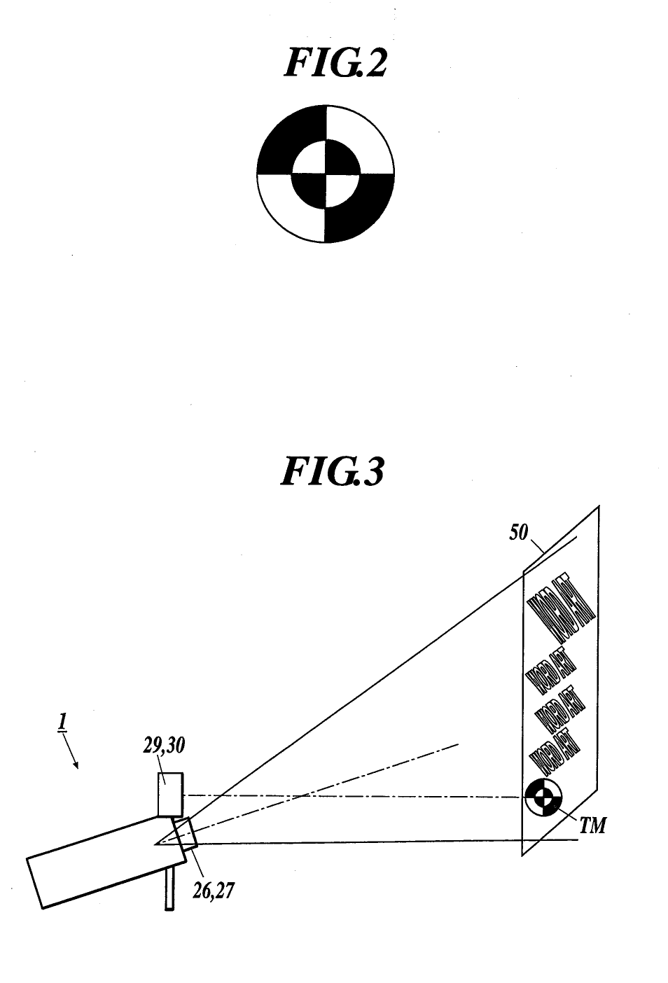

FIG. 2 is a diagram showing one example of a mark image stored in the storage section 13.

As shown in FIG. 2, the mark image represented by image data 14 is a round mark in which white portions (bright portion) and black portions (dark portion) are alternately placed. The white portions and the black portions are alternately placed in each area where the central angle of the circle is divided in a plurality of portions (quadrisection) and the radius of the circle is divided in a plurality of portions (approximately bisection) and the total area of the white portions and the total area of the black portions are the same.

According to the projection type video display apparatus 1 with the above-described structure, the video is projected on the screen with the following process. In other words, when video data or a video signal is input from outside through the video input section 21, a projection video signal based on the video data or video signal is output from the signal processing circuit 23 and supplied to the DMD 25. Then, a lamp light (not shown) is reflected by the DMD 25 and output through the projection lens 26. This light is projected on the screen to display a video.

When the user operates the mark on/off operation section 22a, the mark image is projected with the following process. In other words, when the image data 14 of the mark image is transmitted to the OSD processing section 24, the OSD processing section 24 inserts the signal of the mark image in the projection video signal transmitted from the signal processing circuit 23 to the DMD 3. With this, for example, the mark image shown in FIG. 2 is projected in the left corner portion of the video display projected on the screen. When the user operates the mark on/off operation section 22a while the mark image is projected, the mark image is not shown on the projected video display.

When the user operates the focusing operation section 22b, the processing of automatic focus adjustment is performed with the following process. The automatic focus adjustment processing does not need to start based on the operation of the operation section 22b and may start based on various situations such as starting automatically when power is turned on or when a video is output, starting when the projection type video display apparatus 1 is moved while power is on, or starting with respect to each predetermined time during output of a video.

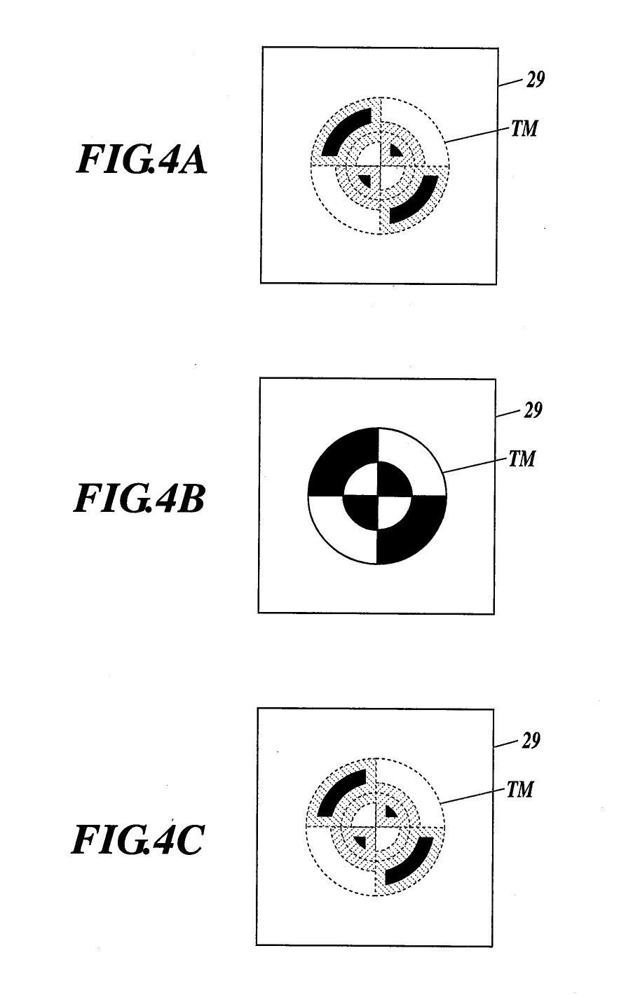

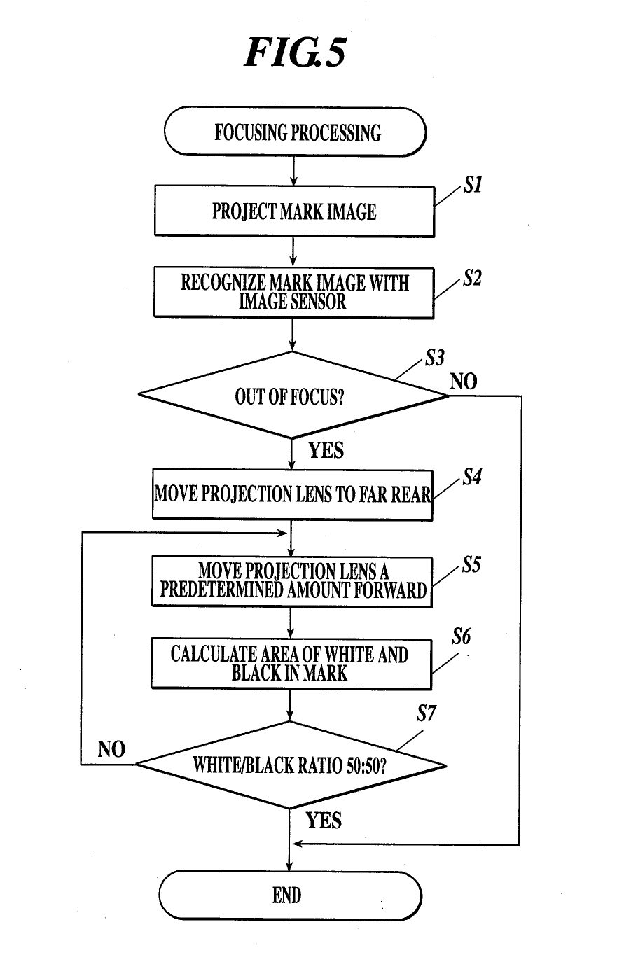

FIG. 3 is an explanatory diagram showing a status during focus adjustment, FIG. 4A is an explanatory diagram showing a projected mark image in front focus, FIG. 4B is an explanatory diagram showing a projected mark image in focus, FIG. 4C is an explanatory diagram showing a projected mark image in back focus, and FIG. 5 is a flowchart showing a procedure of the focusing processing performed by the CPU, respectively.

When the focusing processing shown in FIG. 5 starts, first the CPU 11 transmits the image data 14 in the storage section 13 to the OSD processing section 24 and allows the a mark image TM to be projected (step S1). With this, the mark image TM is displayed on a screen 50.

Next, the image sensor 29 captures the video projected on the screen 50 to extract the portion where the mark image TM is displayed from the captured video and to recognize the mark image TM (step S2). By using a lens with a large depth of focus or using a wide angle lens in deep focus, when the distance to the screen 50 is roughly suitable, the camera lens 30 may capture the video on the screen 50 almost in focus. In this state, the mark image TM on the screen 50 may be projected out of focus or in focus. However, for example, by storing in advance in the storage section 13 imaged data of the mark image TM in a focused state and imaged data of the mark image TM in an unfocused state, and searching whether or not there is a portion close to the imaged data in the image data transmitted from the image sensor 29, the mark image TM may be relatively easily recognized either in a focused or unfocused state.

When the mark image TM is recognized, it is determined from the imaged data whether or not the mark image TM is out of focus (step S3), and when the image is not out of focus, it is determined that the image is in focus and the focusing processing ends. When the image is out of focus, the process advances to the following focus adjustment processing (step S4 to S7).

In the focus adjustment processing, first the focus driving motor 27 is driven to move the projection lens 26 to the far rear end (step S4), and then the projection lens 26 is moved forward by an extremely small predetermined amount (step S5). The image sensor 29 calculates the area of the white portion and the area of the black portion of the mark image TM from the imaged data (step S6).

As shown in FIG. 4A to FIG. 4C, the area ratio of the white portions and the black portions of the mark image TM input in the image sensor 29 are different between when the image is in focus (FIG. 4B) and when the image is unfocused due to the projection lens 26 being too forward (FIG. 4A) or too rear (FIG. 4C). In other words, when the image is in focus, the area ratio of the white portions and the black portions is approximately 50:50, whereas when the image is out of focus the projected light representing white blurs into the black portion and this portion becomes a slightly darkened white. By calculating the area as considering the slightly darkened white portions to be white, the area ratio of the white portion becomes large.

Thus, as described above, after the areas of the white portions and the black portions of the mark image TM are calculated, the area ratio of these areas is calculated and it is determined whether or not the area ratio is approximately 50:50 (step S7). When the area ratio is approximately 50:50, the image is considered to be in focus and the focusing processing ends, whereas when the area ratio is different from 50:50 by a predetermined amount, the projection lens 26 is moved forward again by a predetermined amount (step S5). The processing of moving the projection lens 26 by an extremely small amount and the processing of confirming the area ratio of the white portions and black portions of the mark image TM are repeated and the position of the projection lens 26 is adjusted until the white/black ratio is approximately 50:50. With this, it is considered that the image is in focus, and the focusing processing ends.

As described above, according to the projection type video display apparatus 1 of the present embodiment, the projected video may be automatically focused by the focusing processing. Consequently, the user's trouble necessary when focusing may be relieved. The focus is adjusted by using the video of the mark image TM actually output from the projection lens 26, thus the focus adjustment processing may be done if the video can be projected. When the focus is adjusted by measuring the distance, the type of screen is limited, however in the focus adjustment processing of the present embodiment, there are no such limitations.

The focus adjustment processing is performed by using a predetermined mark image TM, thus image analysis and processing when the mark image TM is recognized from the imaged data or when determining whether the image is unfocused may be easily performed.

The image data of the mark image TM is stored in the storage section 13, thus there is no need to input video data and the like of the mark image from outside. The mark image TM is an image in which the bright portions and the dark portions are positioned alternately, thus it is easy to determine whether or not the projected video is in focus by comparing the areas of the bright portions and the dark portions of the mark image TM.

The mark image TM may be inserted in a projected video and displayed even while a video externally input is displayed. Consequently, the focus adjustment may be performed while viewing a video. The mark image TM can be set so that the mark image TM is not displayed when not necessary by using the operation section 22a which switches the on/off of the output of the mark image TM.

The present invention is not limited to the above-described embodiments and various modifications may be made. For example, an OSD processing section 24 is shown as an example for inserting a mark image in a projected video, however the structure is not limited to this, and the mark image may be inserted in the projected video by inserting the data of the mark image when the projected video is image data. The mark image is not limited to a round image as shown in FIG. 2, and may be a mark with rectangular bright portions and dark portions positioned alternately. Other various marks may also be used.

In the above-described embodiment, an example which uses a DMD as a method of video projection is shown, however the method of video projection is not limited and a method which uses, for example, reflective liquid crystal elements may be used. An example which moves only the projection lens in order to adjust the focus is shown, however, a mechanism for moving the position of the projection type video display apparatus 1 may be provided and the apparatus itself may be moved forward and backward to change the relative position of the projection lens and the screen so that the focus may be adjusted.

Other detail points shown in the present embodiment such as detailed contents of the processing steps of the focusing processing shown in FIG. 5 may be modified without leaving the spirit of the invention.

According to a first aspect of the preferred embodiments, there is provided a projection type video display apparatus comprising:

a video projection section to generate projection light of a video to output through a projection lens;

an imaging section to capture through a camera lens the video projected by the video projection section;

a moving section to move the projection lens in a direction of changing focus of the video; and

a control section to adjust the focus of the projected video, wherein

the control section allows the video projection section to project a pre-set mark image and the imaging section to capture the projected video of the mark image to allow the moving section to operate so that the captured mark image is in focus, and thus adjusts the focus of the projected video.

Preferably, the projection type video display apparatus further comprises a storage section to store image data of the mark image, wherein

the control section allows the video projection section to project the mark image based on the image data.

Preferably, in the projection type video display apparatus, the mark image is an image with a bright portion and a dark portion arranged alternately.

Preferably, in the projection type video display apparatus, the control section determines whether or not the projected video is in focus by comparing areas of the bright portion and the dark portion of the mark image captured by the imaging section.

Preferably, the projection type video display apparatus further comprises:

a video input section to receive input of data or signal of a video; and

an image insertion section to insert a display content of a character or design in the data or signal of the video, wherein

the mark image is inserted in the projected video by the image insertion section while a video input from the video input section is projected by the video projection section.

Preferably, the projection type video display apparatus further comprises an operation section to switch between whether or not to project the mark image.

According to a second aspect of the preferred embodiments, there is provided a projection type video display apparatus comprising:

a video projection section to generate projection light of a video to output through a projection lens;

an imaging section to capture through a camera lens the video projected by the video projection section;

a storage section to store image data of a mark image in which a bright portion and a dark portion are arranged alternately;

a video input section to receive input of data or signal of a video;

an image insertion section to insert a display content of a character or design in the data or signal of the video;

a moving section to move the projection lens in a direction of changing focus of the video; and

a control section to adjust the focus of the projected video, wherein

the control section allows the mark image to be inserted in the projected video by the image insertion section while a video input from the video input section is projected by the video projection section and allows the imaging section to capture the projected video of the mark image to determine whether or not the projected video is in focus by comparing areas of the bright portion and the dark portion of the mark image while allowing the moving section to operate, and thus adjusts the focus of the projected video.

According to these aspects, an automatic focus adjustment of a projected video may be done without causing trouble to the user. The focus adjustment is performed by imaging a video projecting a mark image. Consequently, the type of screen for focus adjustment is not limited. Also, a pre-set mark image is used. Consequently, analyzing and processing of recognizing the mark image or determining whether the image is out of focus may be performed easily.

The entire disclosure of Japanese Patent Application No. 2007-134400 filed on May 21, 2007 including description, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A projection type video display apparatus comprising:
a video projection section to generate projection light of a video to output through a projection lens;
an imaging section to capture through a camera lens the video projected by the video projection section;
a moving section to move the projection lens in a direction of changing focus of the video; and
a control section to adjust the focus of the projected video, wherein
the control section allows the video projection section to project a pre-set mark image and the imaging section to capture the projected video of the mark image to allow the moving section to operate so that the captured mark image is in focus, and thus adjusts the focus of the projected video.

2. The projection type video display apparatus according to claim 1, further comprising a storage section to store image data of the mark image, wherein
the control section allows the video projection section to project the mark image based on the image data.

3. The projection type video display apparatus according to claim 1, wherein the mark image is an image with a bright portion and a dark portion arranged alternately.

4. The projection type video display apparatus according to claim 1, wherein the control section determines whether or not the projected video is in focus by comparing areas of the bright portion and the dark portion of the mark image captured by the imaging section.

5. The projection type video display apparatus according to claim 1, further comprising:
a video input section to receive input of data or signal of a video; and
an image insertion section to insert a display content of a character or design in the data or signal of the video, wherein
the mark image is inserted in the projected video by the image insertion section while a video input from the video input section is projected by the video projection section.

6. The projection type video display apparatus according to claim 1, further comprising an operation section to switch between whether or not to project the mark image.

7. A projection type video display apparatus comprising:
a video projection section to generate projection light of a video to output through a projection lens;
an imaging section to capture through a camera lens the video projected by the video projection section;
a storage section to store image data of a mark image in which a bright portion and a dark portion are arranged alternately;
a video input section to receive input of data or signal of a video;
an image insertion section to insert a display content of a character or design in the data or signal of the video;
a moving section to move the projection lens in a direction of changing focus of the video; and
a control section to adjust the focus of the projected video, wherein
the control section allows the mark image to be inserted in the projected video by the image insertion section while a video input from the video input section is projected by the video projection section and allows the imaging section to capture the projected video of the mark image to determine whether or not the projected video is in focus by comparing areas of the bright portion and the dark portion of the mark image while allowing the moving section to operate, and thus adjusts the focus of the projected video.
